(19) United States
(12) Patent Application Publication
(10) Pub. No.: US 2003/0129213 A1
(43) Pub. Date: Jul. 10, 2003

(54) Meta-stable insect repellent emulsion composition and method of use

(76) Inventors: Anthony D. Gonzalez, Oak Ridge, NJ (US); Andrew H. Pechko, Ridgewood, NJ (US); Vincent T. Polywoda, Suffern, NY (US)

Correspondence Address: Rupa Sen, Avon Products, Inc., Avon Place, Suffern, NY, 10901, US

(21) Appl. No.: 10/334,171

(22) Filed: Dec. 30, 2002

Related U.S. Application Data
(63) Continuation-in-part of application No. 10/032,847, filed on Dec. 26, 2001, now Pat. No. 6,517,816.

(51) Int. Cl. A01N 25/00

(52) U.S. Cl. 424/405

(57) ABSTRACT

There is provided an improved insect repellent emulsion composition. The composition has an inner discontinuous phase and an outer continuous phase. The inner discontinuous phase and/or outer continuous phase has an insect repellent active therein. The inner discontinuous phase is generally dispersed in the outer continuous phase and is in the form of discrete droplets having a multimodal droplet size distribution. There is also provided a method of protecting skin from being bitten by insects in which the above composition is applied topically to the skin. There is also provided a method of enhancing the performance of a insect repellent emulsion by forming the inner discontinuous phase as a multiplicity of droplets having a multimodal droplet size distribution. There is also provided a method of preparing an emulsifier-free insect repellent composition.

### RELATED APPLICATIONS

This application is a continuation-in-part of U.S. application Ser. No. 10/032,847, filed Dec. 26, 2001, which is currently allowed and which is incorporated herein by reference.

### BACKGROUND OF THE INVENTION

1. Field of the Invention

The present invention relates to insect repellent emulsion compositions that provide improved insect repellent protection to skin. The present invention also relates to a method of improving the insect repellent protection provided by a level of insect repellent active. Additionally, the repellency protection provided by an emulsion composition of the present invention also relates to a method of providing same insect repellency using less insect repellent active(s) than prior art insect repellent composition.

2. Description of the Prior Art

Insect repellent compositions are available commercially in the form of emulsions with hydrophobic organic insect repellent actives in the inner discontinuous phase. Such emulsions are shown, by way of example, in U.S. Pat. No. 5,916,541.

Heretofore, it has been traditionally accepted by those skilled in the art that highly stable emulsions (i.e., with small uniform droplet size) were necessary to produce insect repellent emulsions to provide adequate insect repellency. It has been observed that such stable emulsions require the use of relatively high levels of emulsifying agents, film formers and insect repellent actives. The prior art problem to be addressed is how to provide improved insect repellent protection products, preferably maximum insect repellent protection products, with a minimum amount of insect repellent active.

In addition, a common problem associated with traditional insect repellent emulsions is a delay in the onset of repellency after application to the skin. This delay is related to the time required for breaking of the phases of the emulsion which are more stable in a traditional insect repellent emulsion. Consequently, consumers can experience the onset of insect exposure due to this time delay.

Thus, it is desirable to have a stable insect repellent composition in emulsion form that provides enhanced insect repellent protection with a lesser amount of an insect repellent active than previously possible.

### SUMMARY OF THE INVENTION

It is an object of the present invention to provide an insect repellent emulsion composition that provides enhanced insect repellent protection.

It is another object of the present invention to provide an insect repellent emulsion composition that provides a given degree of insect repellent protection with a lesser amount of insect repellent active than previously possible.

It is also another object of the present invention to provide an insect repellent emulsion composition that provides a faster onset of insect repellent action as compared to prior art insect repellent emulsion compositions.

It is still another object of the present invention to provide a method of making such insect repellent emulsion compositions.

It is yet another object of the present invention to provide an insect repellent composition that imparts repellency to the skin immediately or soon after application.

It is yet a further object of the present invention to provide a method of protecting skin from insect pests and the damage (e.g., disease, allergic reactions) associated therewith.

These and other objects and advantages of the present invention are provided in the present insect repellent composition by reducing the steric stability of an insect repellent emulsion composition, i.e., by preparing a meta-stable emulsion. The emulsion has an inner discontinuous phase and an outer continuous phase. The inner discontinuous phase and/or outer continuous phase has at least one insect repellent active therein. The inner discontinuous phase is generally dispersed within the outer continuous phase in the form of discrete droplets having a multimodal droplet size distribution.

### BRIEF DESCRIPTION OF THE DRAWINGS

FIG. 1 illustrates a representation of a unimodal (i.e., uniform/homogeneous) droplet size distribution of a conventional (i.e., prior art) emulsion.

FIG. 2 illustrates a representation of a meta-stable emulsion of the present invention having a bimodal (i.e., non-uniform/heterogeneous) droplet size distribution range.

FIG. 3 illustrates a representation of a meta-stable emulsion of the present invention having a trimodal (i.e., non-uniform/heterogeneous) droplet size distribution range.

FIG. 4 graphically illustrates the particle size distribution of embodiment of the present invention having a trimodal droplet size distribution range.

### DESCRIPTION OF THE INVENTION

As stated above, the prior art teaches that, in order to obtain efficacious insect repellent protection from an insect repellent emulsion composition, the emulsion must be stable. This inherently means that the droplet size distribution throughout the emulsion is uniform/homogenous. By maintaining such uniform droplet size distribution, the droplets are less likely to come together and cause the internal and external phases of the emulsion to separate and become unstable. To maintain this uniform droplet size distribution, a relatively high degree of emulsifying agent is required, typically 10 percentage by weight or weight percent (wt %) or more based on the total weight of the inner phase components. By lowering the amount of emulsifying agent, the droplet size distribution becomes increasingly heterogeneous and causes the emulsion to become meta-stable and, ultimately, unstable if a very low amount or no emulsifying agent is used. It has, heretofore, been the common understanding that, as the stability of an insect repellent emulsion composition decreases, the insect repellent performance of such a composition similarly decreases. Contrary to the teachings of the prior art, it has now been unexpectedly and surprisingly found that insect repellent emulsion compositions with reduced steric stability (i.e., emulsions that have a heterogeneous/multi-modal droplet size distribution) provide better insect repellent performance (e.g., a longer time period of insect repellency) than prior art stable emulsions (i.e., emulsions that have uniform/unimodal/homogeneous droplet size distribution) having equal amounts of the same insect repellent active. Alternatively, insect repellent emulsions with reduced steric stability (i.e., meta-stable emulsions) can impart the same repellency as sterically stable insect repellent emulsions, but with lesser amounts of insect repellent active(s).

In addition, the meta-stable emulsion compositions of the present invention break more quickly than prior art emulsions, thus allowing a quicker “release” of the insect repellent from within the emulsion, and thereby allowing a faster onset of insect repellency activity as compared to prior art insect repellent emulsion compositions.

As used herein the terms “wt %” or “percentage by weight” indicates percentages based upon the total weight of the composition unless otherwise stated.

As used herein, the term “repellency enhancement” includes, as compared to prior art insect repellent compositions (i.e., emulsions with homogeneous droplets), (1) increasing repellency times of the composition without increasing the concentration of insect repellent active, and (2) maintaining the same repellency times with lower concentrations of insect repellent active. The main requirement for repellency enhancement is that the emulsion of the present invention must be meta-stable, with heterogeneous droplets.

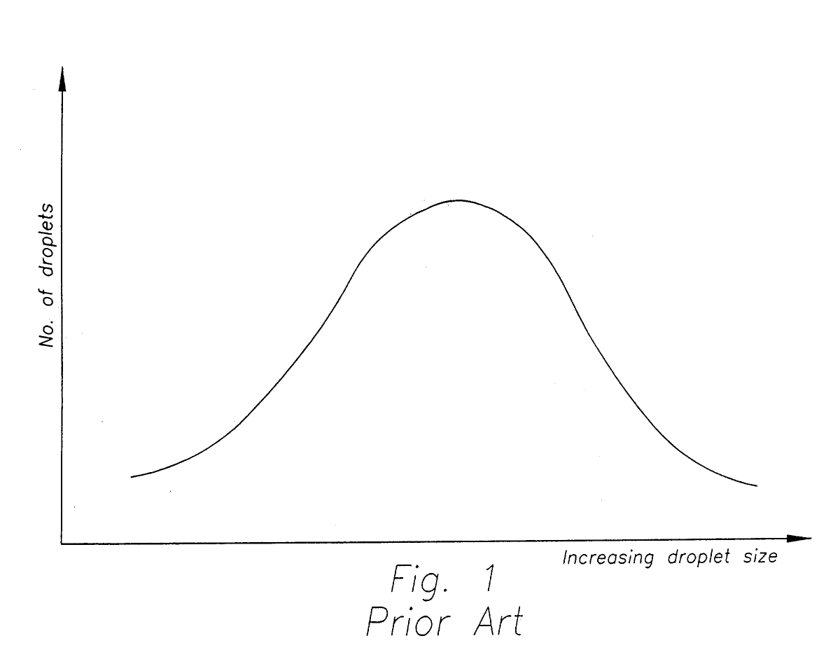

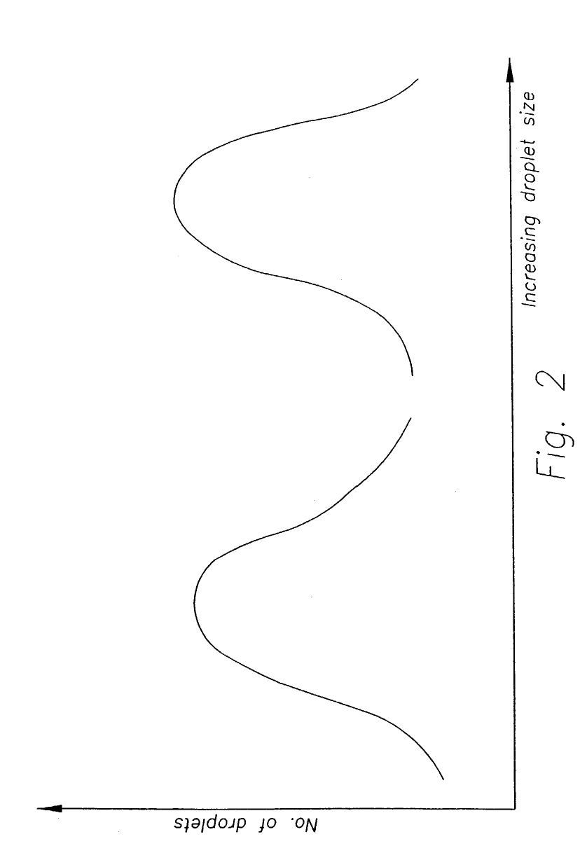

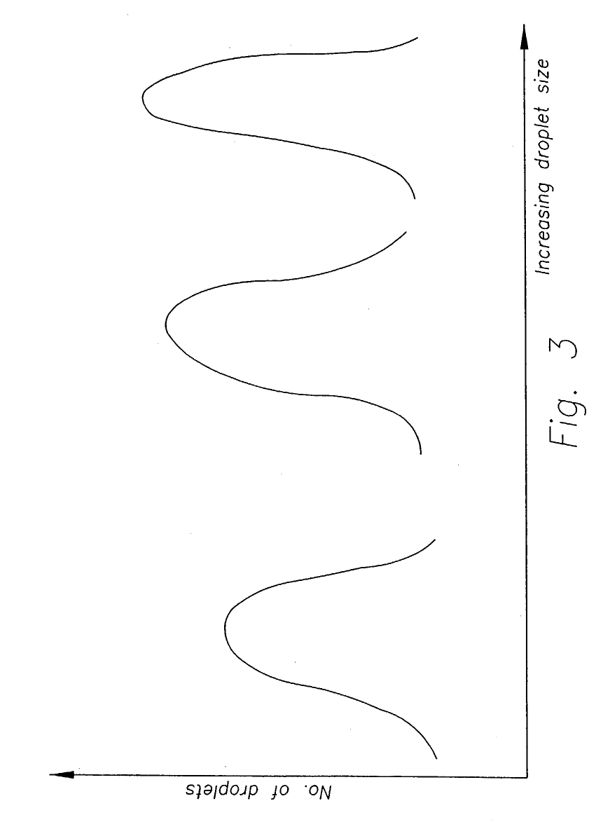

In the present invention, a meta-stable emulsion can be prepared by simply reducing the amount of traditional emulsifying agent used to emulsify the inner and outer phases of the emulsion. Alternatively, the traditional emulsifying agents can be replaced altogether with certain co-solvents, as will be described herein. Similarly, an emulsion composition can be converted from stable to meta-stable by raising the concentration of the inner phase of the emulsion and/or by decreasing the external phase of the emulsion. In either case, the inner and outer phases of the emulsion will be emulsified only to a point where the emulsion is meta-stable. In other words, the emulsion will not have the uniform droplet size distribution associated with highly stable emulsions. This type of distribution is referenced to as unimodal and is shown in FIG. 1. Rather, the meta-stable emulsion of the present invention will inherently have a heterogeneous droplet size distribution (that accounts for its meta-stability). This type of distribution is referred to as multimodal (shown in FIGS. 2 and 3) because the droplets are present in the emulsion in at least two different size distribution ranges, as would be easily determinable by viewing the emulsion under a light microscope or by laser particle size analyzer.

A composition that has two different droplet size ranges may also be referred to as “bimodal”. A composition with three different ranges may also be referred to as “trimodal.” A composition with four or more different ranges or in a wide range of droplet sizes may also be referred to as “polymodal.”

A bimodal droplet size distribution is represented in FIG. 2. As is appreciated, there are two discrete droplet size ranges. In other words, a majority of the droplet sizes fall within the two discrete ranges as represented by the area under the curves. A non-limiting example of such a bimodal emulsion of the present invention includes a first droplet size range about 0.20 to about 1.3, more preferably 0.37 to about 0.9, microns, and a second droplet size range about 0.85 to about 4.2, more preferably about 1.4 to about 3.0 microns.

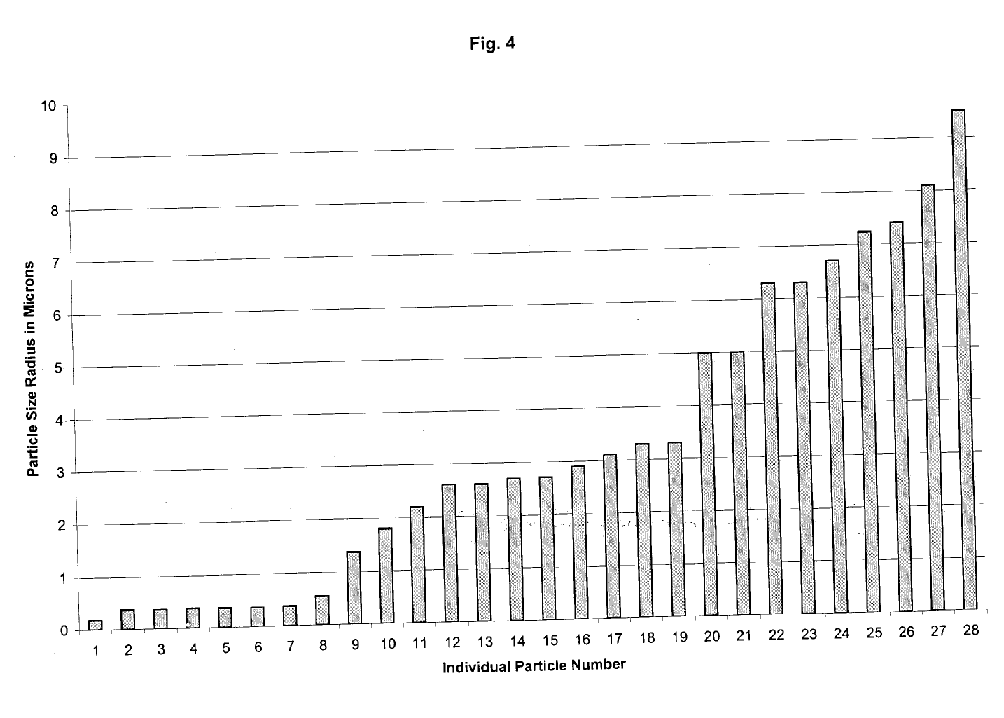

A trimodal droplet size distribution is represented in FIG. 3. As is appreciated, there are three discrete droplet size ranges. In other words, a majority of the droplet sizes fall in the three discrete ranges as represented by the area under the curves. A non-limiting example of such a trimodal emulsion of the present invention has a first droplet size range from about 0.1 to about 0.8, more preferably from about 0.18 to about 0.55, microns; a second droplet size range from about 1.1 to about 4.6, more preferably about 1.8 to about 3.3, microns; and a third droplet size range from about 3 to about 16.7, more preferably from about 5.0 to about 11.9, microns. A trimodal emulsion conforming to the foregoing was made and the particle size distribution of twenty-eight particles was measured using a NIKON E800 MICROSCOPE at 400× magnification combined with IMAGE PRO PLUS SOFTWARE. The results are set forth numerically below in Table 1 and graphically in FIG. 4.

TABLE 1

| Distribution Range 1 | | Distribution Range 2 | | Distribution Range 3 | |
|---|---|---|---|---|---|
| Particle | Particle Size | Particle | Particle Size | Particle | Particle Size |
| No. | Radius in Microns | No. | Radius in Microns | No. | Radius in Microns |
| 1 | 0.18 | 9 | 1.37 | 20 | 5 |
| 2 | 0.37 | 10 | 1.8 | 21 | 5 |
| 3 | 0.37 | 11 | 2.2 | 22 | 6.3 |
| 4 | 0.37 | 12 | 2.6 | 23 | 6.3 |
| 5 | 0.37 | 13 | 2.6 | 24 | 6.7 |
| 6 | 0.37 | 14 | 2.7 | 25 | 7.24 |
| 7 | 0.37 | 15 | 2.7 | 26 | 7.4 |
| 8 | 0.55 | 16 | 2.9 | 27 | 8.1 |
| | | 17 | 3.1 | 28 | 9.1 |
| | | 18 | 3.3 | | |
| | | 19 | 3.3 | | |

As employed herein, “particle size radius” refers to droplet radius, which when doubled corresponds to “droplet diameter” (a.k.a. “droplet size”). Either particle size radius and/or droplet size may be determined via microscopy using image analysis software or by using a laser particle size analyzer.

With respect to the present invention, the droplet size and droplet size ranges are not to be limited to a specific size or range of sizes. Rather, it is more important that the insect repellent emulsion have at least two discrete droplet size ranges. Preferably, at least about 50 wt % of the droplets fall within the discrete droplet size ranges based upon the total weight of droplets. Still more preferably, at least about 70 wt % to about 90 wt % of the droplets fall within the discrete droplet size ranges based upon the total weight of droplets.

The composition may preferably take the form of an oil-in-water emulsion, a water-in-oil emulsion, a water-in-silicone emulsion, a silicone-in-water emulsion, oil-in-oil emulsion, polyol-in-silicone emulsion, a multiple emulsion, and an inverse emulsion. An oil-in-water emulsion is more preferred.

The present composition has an insect repellent active in either the inner discontinuous phase or outer continuous phase of the emulsion. The insect repellent active may be organic or inorganic and water-soluble or oil-soluble. The insect repellent active is preferably one that is suitable for application to human skin, but insect repellents that are suitable for application to pets, such as cats or dogs, or livestock, active should be used in an amount sufficient to exert insect repellent activity without causing toxicity. Preferably, the insect repellent is used in an amount sufficient to provide insect repellency without human toxicity. Suitable non-limiting examples of insect repellent actives include: ethyl butylacetylaminopropionate (available under the trade name “IR3535” from Merck Co), p-menthane-3,8-diol, hydroxyethyl isobutyl piperidine carboxylate (1-piperidinecarboxylic acid) (available under the trade name “Bayer KBR 3023”), N,N diethyl-m-toluamide (also known and referred to herein as “DEET”), camphor, di N-propyl isocinchomeronate, ethyl hexanediol, essential oils such as eucalyptus oil, geranium/geraniol oil, oil of citronella, lemongrass, piperonyl butoxide, soybean oil, pyrethrum, pyrethrins, nepetalactone, and any combinations thereof. Ethyl butylacetylaminopropionate, p-menthane-3,8-diol, hydroxyethyl isobutyl piperidine carboxylate (1-piperidinecarboxylic acid), DEET and any mixture thereof are preferred insect repellent actives. It is most preferred that for the insect repellent compositions of the present the insect repellent active is or includes ethyl butylacetylaminopropionate.

The amount of insect repellent active employed will depend on the level of protection desired. Insect repellent amounts may vary depending upon insect repellent active employed. The amount of insect repellent can be adjusted using standard empirical routines for optimization, as is well understood in the art. Generally, the insect repellent active is present from about 0.01 wt % about 70 wt %, more preferably from about 0.05 wt % to about 50 wt %, and most preferably from about 0.5 wt % to about 30 wt %, based on the total weight of the based on the total weight of the composition.

The composition has an aqueous phase that is about 5 wt % to about 90 wt %, preferably about 10 wt % to about 80 wt %, and most preferably about 15 wt % to about 75 wt % water, based on the total weight of the composition.

The present composition may include any vehicle known in the art as useful in formulating emulsions. Suitable vehicles include, but are not limited to, water; one or more vegetable oils; esters such as octyl palmitate, isopropyl myristate and isopropyl palmitate; ethers such as dicapryl ether and dimethyl isosorbide; alcohols such as ethanol and isopropanol; fatty alcohols such as cetyl alcohol, stearyl alcohol and behenyl alcohol; isoparaffins such as isooctane, isododecane and isohexadecane; silicone oils such as dimethicones and polysiloxanes; hydrocarbon oils such as mineral oil, petrolatum, isoeicosane and polyisobutene; polyols such as propylene glycol, glycerin, butylene glycol, pentylene glycol and hexylene glycol; or any combinations of the foregoing.

The composition may have an emulsifier present in a limited amount effective to provide and maintain a heterogeneous, meta-stable dispersion of the inner discontinuous phase in the outer continuous phase, in which the heterogeneous droplets are in multimodal droplet size ranges. Preferably, the emulsifier will be present in an amount up to about 5 wt %, more preferably up to about 2 wt %, even more preferably up to about 1%, and most preferably up to about 0.5 wt %, based upon the total weight of the inner phase components/ingredients.

Of course, the level of emulsifier used can be modified by those skilled in the art, especially when using more powerful emulsifiers such as polymerics and/or cosolvents such as polyols. The excipients of the composition can be selected to alter the required emulsifier level as well. For example, including a more polar oil, such as isopropylmyristate, instead of a nonpolar oil, such as a hydrocarbon oil, allows the amount of emulsifier required to maintain a meta-stable emulsion to be decreased.

Emulsifiers that can be used in the present compositions include, but are not limited to, one or more of the following: sorbitan esters such as sorbitan monooleate and sorbitan monostearate; polyglycerol esters and glycerol esters such as glycerol monostearate and glycerol monooleate; polyoxyethylene phenols such as polyoxyethylene octyl phenol and polyoxyethylene nonyl phenol; polyoxyethylene ethers such as polyoxyethylene cetyl ether and polyoxyethylene stearyl ether; polyoxyethylene glycol esters; polyoxyethylene sorbitan esters; polyglyceryl-3-diisostearate; polyglyceryl-3-distearate; PEG-30 dipolyhydroxystearate; quaternary ammonium compounds; dimethicone copolyol; cetyl dimethicone copolyol; lecithin and its components; alkyl polyglucosides; acrylates/C₁₀-C₃₀ alkyl acrylate copolymers; sodium stearoyl lactylate; organic phosphate salts; sodium cetearyl sulfate; or any combinations thereof, or any other component that can sufficiently reduce the surface tension between phases to allow for the formation of discrete inner phase droplets. Additional useful emulsifiers and co-emulsifiers are provided in U.S. Pat. Nos. 5,162,378 (column 4) and 5,344,665 (Table 1), which are incorporated herein by reference.

The meta-stable emulsions of the present invention may be made substantially emulsifier free and still provide insect repellent enhancement. As used herein, the term “substantially emulsifier-free” means less than about 1 wt % emulsifying agent based on the total weight of the oil phase. When the meta-stable emulsion is substantially emulsifier-free, it is preferred that the emulsion includes at least one co-solvent with low surface activity (i.e., can reduce surface tension to help emulsify the emulsion phases, but without producing a fully stable emulsion). The co-solvents that can be used in the present composition include, but are not limited to, primary alcohols such as ethanol, one or more polyols, such as butylene glycol, ethylene glycol, propylene glycol and hexylene glycol; esters such as octyl palmitate, isopropyl myristate and isopropyl palmitate; ethers such as dicapryl ether and dimethyl isosorbide; ethoxylated esters; propoxylated esters; propoxylated alcohols; and alkoxylated alcohols such as polyethylene glycol. Preferably, the co-solvent is a polyethylene glycol. Suitable non-limiting examples of polyethylene glycols useful in the present invention include polyethylene glycol 1450 and polyethylene glycol 300.

It is preferred that the ratio of co-solvent to insect repellent is about 0.5:1 to about 10:1, more preferably about 0.5:1 to about 5:1, and optimally at about 1:1.

When preparing such an emulsifier-free composition, it is most preferable to mix the insect repellent and co-solvent together before any other ingredients are added to the insect repellent.

The present invention may also incorporate emulsion stabilizers to impede the coalescence of the internal phase droplets. Such stabilizers may include, but are not limited to, polymers such as carbomer and polyurethane, cellulosics (organo-modified and otherwise), clays such as bentonite and its derivative, suspending powders such as silica, and polymethylmethacrylate. In the case of inverse emulsions, salts such as magnesium sulfate heptahydrate may also be used as emulsion stabilizers. Lowering the concentration of emulsion stabilizers in a stable cosmetic emulsion will also contribute to converting such stable emulsion to a meta-emulsion.

The present composition may optionally include one or more of the following ingredients: anesthetics, anti-allergenics, antifungals, antimicrobials, anti-inflammatories, antiseptics, chelating agents, botanical extracts, colorants, depigmenting agents, emollients, exfollients, film formers, fragrances, humectants, sunscreens, lubricants, moisturizers, pharmaceutical agents, preservatives, skin protectants, skin penetration enhancers, stabilizers, surfactants, thickeners, viscosity modifiers, vitamins, or any combinations thereof. A non-limiting list of suitable sunscreens useful in the present invention is disclosed in allowed copending U.S. application Ser. No. 10/032,847, filed Dec. 26, 2001, which has been incorporated herein by reference.

Suitable film formers may also be chosen by those skilled in the art. A non-limiting list of film formers includes: acrylate copolymers, acrylate/octylacrylamide copolymers, acrylate/VA copolymer, amodimethicone, AMP/acrylate copolymers, behenyl beeswax, behenyl/isostearyl, beeswax, butylated PVP, butyl ester of PVM/MA copolymers, calcium/sodium PVM/MA copolymers, dimethicone, dimethicone copolyol, dimethicone/mercaptopropyl methicone copolymer, dimethicone propylethylenediamine behenate, dimethicolnol ethylcellulose, ethylene/acrylic acid copolymer, ethylene/MA, copolymer, ethylene/VA copolymer, fluoro C2-8 alkyldimethicone, hexanediol beeswax, hydrogenated styrene/butadiene copolymer, hydroxyethyl ethylcellulose, isobutylene/MA copolymer, laurylmethicone copolyol, methyl methacrylate crosspolymer, methylacryloyl ethyl betaine/acrylates copolymer, microcrystalline wax, nitrocellulose, octadecene/MA copolymer, octadecene/maleic anhydride copolymer, octylacrylamide/acrylate/butylaminoethyl methacrylate copolymer, oxidized polyethylene, perfluoropolymethylisopropyl ether, polyacrylic acid, polyethylene, polymethyl methacrylate, polypropylene, polyquaternium-10, polyquaternium-11, polyquaternium-28, polyquaternium-4, PVM/MA decadiene crosspolymer, PVM/MA copolymer, PVP, PVP/decene copolymer, PVP/eicosene copolymer, PVP/hexadecene copolymer, PVP/MA copolymer, PVP/VA copolymer, silica, silica dimethyl silicate, sodium acrylate/vinyl alcohol copolymer, stearoxy dimethicone, stearoxytrimethylsilane, stearyl alcohol, stearylvinyl ether/MA copolymer, styrene/DVB copolymer, styrene/MA copolymer, tetramethyl tetraphenyl trisiloxane, tricontanyl trimethyl pentaphenyl trisiloxane, trimethylsiloxysilicate, VA/crotonates copolymer, VA/crotonates/vinyl proprionate copolymer, VA/butyl maleate/isobornyl acrylate copolymer, vinyl caprolactam/PVP/dimethylaminoethyl methacrylate copolymer, and vinyldimethicone. Preferred film formers include poly(vinyl pyrrolidone/1-triacontene) (available under the trade name TRICONTONYL PVP), acrylate copolymers, PVP/eicosene copolymer, PVP/hexadecene copolymer, PVP/MA copolymer, PVP/VA copolymer and polyurethanes, such as Polyurethane-1, Polyurethane-2, Polyurethane-4, Polyurethane-5 and polyesters.

While the inventors do not wish to be bound by any one theory, it is believed that the meta-stable emulsions of the present invention may provide insect repellent enhancement by forming a more uniform film, thus making the addition of a film former unnecessary. However, conventional film formers may still be added to the present invention, if desired.

The composition can be made into any suitable product form. Such product forms include, but are not limited to, a cream, a lotion, a gel, a mousse, a solution, and an aerosol or pump spray. In addition, the composition may be incorporated into a stick, towelette, or patch.

The composition may be formulated in any manner known in the art for forming an emulsion having an insect repellent. Typically, the aqueous phase and the oil phase will be separately formulated and subsequently mixed. The main requirement for insect repellency enhancement under the present invention is that the emulsion be meta-stable. The stability of an emulsion is based principally on a physical observation test. Basically, the emulsion is put through 3 freeze/thaw cycles in which the temperatures are alternated between a low of about 40° F. to a high of about 120° F. The emulsion is then observed at 4 week and 8 week intervals. The product is deemed stable if no separation of the phases occurs, and the product maintains physical integrity, such as viscosity and pH parameters.

### COMPARATIVE EXAMPLES

The following examples are intended to only illustrate meta-stable compositions of the present invention as compared to traditional emulsion compositions, should not be construed as limiting the scope of the present invention.

| | Meta-Stable | |
|---|---|---|
| | Emulsions | Traditional |
| | (Present | Emulsions |
| | Invention) | (Prior Art) |
| Ingredient | wt % | wt % |
| Insect repellent (e.g., DEET, Citronella, | 0.5 to 30 | 0.5 to 30 |
| IR3535) | | |
| Primary Emulsifier (e.g., DEA cetyl phos- | 0-2.5 | 2.0-8.0% |
| phate, PEG-100 stearate) | | |
| CoEmulsifiers (e.g., behenyl alcohol, poly- | 0 | 0.5-5 |
| glyceryl stearate cetyl alcohol, choleth-24) | | |
| Co-solvent (e.g., ethanol, butylene glycol) | 35-55 | 0-10 |
| Thickening Polymers (e.g., carbomer, acry- | 0 | 0.1-1.0 |
| lates copolymer) | | |
| Preservative (e.g., Methylparaben, imidurea) | 0.3-1 | 0.3-1.5 |
| Film Former (e.g. polyurethane-1, PVP hex- | 0-5 | 0-5 |
| adecane copolymer) | | |
| Thickening Gums (e.g., xanthan gum, | 0-1 | 0-2.0 |
| carageenan) | | |
| Emollient oils/esters (e.g., Octyldodecanol, | 0-35 | 0-35 |
| isopropyl myristate) | | |
| Chelating Agent (e.g., citric acid, disodium | 0-1 | 0.1 |
| EDTA | | |
| Sunscreen (e.g., PARSOL 1789; octinoxate, | 0-35 | 0-35 |
| oxybenzone) | | |
| Water | QS | QS |

It should be understood that the foregoing description is only illustrative of the present invention. Various alternatives and modifications can be made by those skilled in the art without departing from the present invention. Accordingly, the present invention is intended to embrace all such alternatives, modifications and variances that fall within the scope of the appended claims.

What is claimed is:

1. An emulsion composition, comprising:
an insect repellent active;
an inner discontinuous phase; and
an outer continuous phase,
wherein the composition is meta-stable.

2. The composition of claim 1, wherein the inner discontinuous phase is a plurality of droplets having a multimodal droplet size distribution.

3. The composition of claim 1, wherein the composition takes the form of an oil-in-water emulsion.

4. The composition of claim 1, wherein the composition takes the form of an emulsion selected from the group consisting of an oil-in-water emulsion, a water-in-oil emulsion, a water-in-silicone emulsion, a silicone-in-water emulsion, oil-in-oil emulsion, polyol-in-silicone emulsion, a multiple emulsion, and an inverse emulsion.

5. The composition of claim 1, wherein the emulsion has a heterogeneous droplet size distribution.

6. The composition of claim 1, wherein the droplet size distribution is bimodal.

7. The composition of claim 1, wherein the droplet size distribution is trimodal.

8. The composition of claim 1, wherein the droplet size distribution is polymodal.

9. The composition of claim 1, wherein the insect repellent active is selected from the group consisting of ethyl butylacetylaminopropionate, p-menthane-3,8-diol, hydroxyethyl isobutyl piperidine carboxylate, N,N diethyl-m-toluamide, camphor, di N-propyl isocinchomeronate, ethyl hexanediol, eucalyptus oil, geranium/geraniol oil, lemongrass nepetalactone, oil of citronella, piperonyl butoxide, soybean oil, pyrethrum, and any combination thereof.

10. The composition of claim 1, wherein the composition comprises from about 0.01 wt % about 70 wt % of said insect repellent active.

11. The composition of claim 1, wherein the composition comprises about 0.05 wt % to about 50 wt % of said insect repellent active.

12. The composition of claim 1, wherein composition comprises about 0.5 wt % to about 30 wt % of said insect repellent.

13. The composition of claim 1, wherein the composition is substantially free of an emulsifying agent.

14. The composition of claim 1, wherein composition comprises less than about 1 wt % of an emulsifying agent.

15. The composition of claim 14, further comprising a co-solvent.

16. The composition of claim 15, wherein the co-solvent is selected from the group consisting of one or more polyols, esters, ethers, propoxylated esters, propoxylated alcohols, and alkoxylated alcohols, and any combinations thereof.

17. The composition of claim 15, wherein the co-solvent is polyethylene glycol.

18. The composition of claim 1, wherein the composition is in a product form selected from the group consisting of a cream, a lotion, a gel, a mousse, a solution, an aerosol spray, and a pump spray.

19. The composition of claim 1, further comprising an ingredient selected from the group consisting of one or more anesthetics, anti-allergenics, antifungals, antimicrobials, anti-inflammatories, antiseptics, botanical extracts, chelating agents, colorants, depigmenting agents, emollients, exfollients, film formers, fragrances, humectants, sunscreens, lubricants, moisturizers, pharmaceutical agents, preservatives, skin protectants, skin penetration enhancers, stabilizers, surfactants, thickeners, viscosity modifiers, vitamins, and any combinations thereof.

20. The composition of claim 1, wherein the composition further comprises up to about 5 wt % of an emulsifier wherein the wt % is based on the total weight of the inner phase.

21. The composition of claim 1, wherein the composition further comprises up to about 2 wt % of an emulsifier wherein the wt % is based on the total weight of the inner phase.

22. The composition of claim 1, wherein the composition further comprises up to about 0.5 wt % of an emulsifier wherein the wt % is based on the total weight of the inner phase.

23. A method of protecting skin from being bitten by insects, comprising applying topically to the skin the emulsion composition according to claim 1.

24. A method of enhancing the performance of a insect repellent composition, comprising forming an emulsion having an inner discontinuous phase and an outer continuous phase, adding a insect repellent active to the emulsion, and rendering the emulsion meta-stable.

25. The method of claim 24, wherein the emulsion has a plurality of droplets of multimodal droplet size distribution.

26. A method of preparing an insect repellent emulsion composition that is substantially free of emulsifying agent, comprising:
combining an insect repellent and at least one co-solvent to form a mixture;
forming an emulsion having an inner discontinuous phase and an outer continuous phase;
introducing the mixture into the emulsion; and
rendering the emulsion meta-stable.

27. The method of claim 26, wherein the emulsion has a plurality of droplets of multimodal droplet size distribution.
